(19) United States
(12) Patent Application Publication
(10) Pub. No.: US 2019/0301594 A1
(43) Pub. Date: Oct. 3, 2019

(54) METHODS AND SYSTEMS FOR ELECTRONIC SHIFTER INSTRUCTION

(71) Applicant: GM GLOBAL TECHNOLOGY OPERATIONS LLC, Detroit, MI (US)

(72) Inventors: Orson S. Wang, Novi, MI (US); MICHAEL A. HICHME, ROCHESTER HILLS, MI (US)

(21) Appl. No.: 15/939,351

(22) Filed: Mar. 29, 2018

(51) Int. Cl. F16H 59/10; F16H 61/68; F16H 61/70; F16H 61/02; F16H 63/42; F16H 59/02; B60W 30/18; B60W 10/111

(52) U.S. Cl. CPC F16H 59/105; F16H 61/68; F16H 61/702; B60W 10/111; F16H 63/42; F16H 59/0204; B60W 30/1819; F16H 61/0213

(57) ABSTRACT

A method for determining a transmission gear selection includes providing a vehicle sensor configured to measure a vehicle characteristic, providing at least one controller in communication with the vehicle sensor, receiving, by the controller, sensor data indicative of the vehicle characteristic, determining, by the controller, an intended transmission gear selection, and generating, by the controller, a control signal including an instruction for selection of the intended transmission gear selection.

### INTRODUCTION

The present invention relates generally to the field of vehicles and, more specifically, to an electronic shifter and predictive operator instruction in the use thereof.

Motor vehicles include a power plant (e.g. engine or electric motor) that produces driving power. The driving power is transferred through a transmission to a driveline for driving a set of wheels at selected gear ratios. As is well known, automatic transmissions shift automatically to the appropriate gear ratio based on various vehicle operating conditions including speed and torque. Typically, a desired transmission operating mode is selected by the vehicle operator.

Traditionally, an operator interface device is provided which the vehicle operator shifts to select the desired transmission range. The operator interface device is electronically linked to the automatic transmission by an electronic shift system or “shift-by-wire” shift system. Typically, a shift-by-wire shift mechanism is based on detection of an external input through the operator interface device. Switches associated with the operator interface device send a mode signal to a transmission control module that is indicative of the selected transmission range. Thereafter, the control module actuates electric motors, solenoids, and/or hydraulics to operate the transmission in a manner corresponding to the range select position.

### SUMMARY

Embodiments according to the present disclosure provide a number of advantages. For example, embodiments according to the present disclosure enable predictive instructions to be displayed to the vehicle operator in advance of a shifting operation. By displaying instructions to the operator prior to the shifting operation, shifting event errors, such as incomplete range selection, can be avoided. Furthermore, predicting the operator's range selection intent (such as, for example and without limitation, from park to reverse or from reverse to drive) can enable more timely and accurate instructions to be displayed to the operator, improving the user experience.

In one aspect, a method for determining a transmission gear selection includes the steps of providing a vehicle sensor configured to measure a vehicle characteristic, providing at least one controller in communication with the vehicle sensor, receiving, by the controller, sensor data indicative of the vehicle characteristic, determining, by the controller, an intended transmission gear selection, and generating, by the controller, a control signal including an instruction for selection of the intended transmission gear selection.

In some aspects, the vehicle characteristic includes one or more of a brake pedal position, a passenger cabin occupancy detection, an ignition position, an elapsed time since a vehicle key on event, a current transmission position, a contact with a capacitive sensor, a vehicle position, an operator seat position, an elapsed time since an adjustment to the operator seat position, a vehicle mirror position, and an elapsed time since an adjustment to the position of the vehicle mirror.

In some aspects, determining the intended transmission gear selection includes analyzing the sensor data to determine if a first condition is satisfied.

In some aspects, the first condition includes one or more of the adjustment to the operator seat position within a predetermined elapsed time and the adjustment to the position of the vehicle mirror within a predetermined elapsed time.

In some aspects, the predetermined elapsed time is a minute since a vehicle key on event.

In some aspects, generating the instruction for selection of the intended transmission gear selection includes analyzing the sensor data to determine if a second condition is satisfied.

In some aspects, the second condition includes one or more of the brake pedal position is a depressed position and contact with the capacitive sensor.

In some aspects, the instruction includes pictorial directions to change a position of an electronic gear selector.

In some aspects, the instruction includes textual directions to change a position of an electronic gear selector.

In some aspects, the instruction includes auditory directions to change a position of an electronic gear selector.

In another aspect, a method for instructing a vehicle operator includes the steps of providing a vehicle sensor configured to measure a vehicle characteristic, providing at least one controller in communication with the vehicle sensor, receiving, by the controller, sensor data indicative of the vehicle characteristic, determining, by the controller, whether a first condition is satisfied, if the first condition is satisfied, generating a first control signal including a first instruction, determining, by the controller, whether a second condition is satisfied, and if the first and second conditions are satisfied, generating, by the controller, a second control signal including a second instruction.

In some aspects, the first and second instructions include pictorial directions to change a position of an electronic gear selector.

In some aspects, the vehicle characteristic includes one or more of a brake pedal position, a passenger cabin occupancy detection, an ignition position, an elapsed time since a vehicle key on event, a current transmission position, a contact with a capacitive sensor, a vehicle position, an operator seat position, an elapsed time since an adjustment to the operator seat position, a vehicle mirror position, and an elapsed time since an adjustment to the position of the vehicle mirror.

In some aspects, determining whether the first condition is satisfied includes determining whether a brake pedal position is in a depressed position.

In some aspects, the first instruction includes illumination of an indicator on an electronic gear selector indicating a direction to adjust a position of the electronic gear selector to a first adjusted position.

In some aspects, determining whether the second condition is satisfied includes verifying that the electronic gear selector is in the first adjusted position.

In some aspects, the second instruction includes illumination of an indicator on the electronic gear selector indicating a direction to adjust the position of the electronic gear selector to a second adjusted position.

### BRIEF DESCRIPTION OF THE DRAWINGS

The present disclosure will be described in conjunction with the following figures, wherein like numerals denote like elements.

FIG. 1 is a schematic block diagram of an electronic transmission range selection system, according to an embodiment.

FIG. 2 is a perspective view of an exemplary electronic gear shifter that is mounted to a steering column of a vehicle, according to an embodiment.

FIG. 3 is a schematic illustration of an exemplary four-position shift pattern that can be used with the electronic gear shifter of FIG. 2, according to an embodiment.

FIG. 4 is a schematic illustration of an exemplary notification message, according to an embodiment.

FIG. 5 is a flowchart representation of a method for proactively instructing an operator through a transmission gear selection, according to an embodiment.

FIG. 6 is a flowchart representation of another method for proactively instructing an operator through a transmission gear selection, according to an embodiment.

FIG. 7 is a flowchart representation of another method for proactively instructing an operator through a transmission gear selection, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be For example, terms such as “above” and “below” refer to directions in the drawings to which reference is made. Terms such as “front,” “back,” “left,” “right,” “rear,” and “side” describe the orientation and/or location of portions of the components or elements within a. consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof and words of similar import.

Some electronic shift systems, including shift systems having an electronic gear shifter mounted on the steering column, are not intuitive to the vehicle operator. In particular, a column-mounted electronic shifter with protections against inadvertent shifts (such as, for example, a 2-motion pattern for shifts into reverse and drive) can be difficult for operators to learn to use. Specifically, some electronic shift systems lack visual cues as to how to move the gear shifter to select the desired range. Embodiments discussed herein provide visual and/or auditory real-time cues or instructions to the vehicle operator to direct the operator through selection of a desired range for electronic shift systems mounted anywhere within the vehicle. In some embodiments, the real-time instructions are based on predictive information gathered from one or more vehicle sensors that indicate, for example, the vehicle operator's intended range selection or whether an operator who may be unfamiliar with the electronic shift system is operating the vehicle. By predicting the vehicle operator's intended range selection, range selection errors may be reduced or minimized.

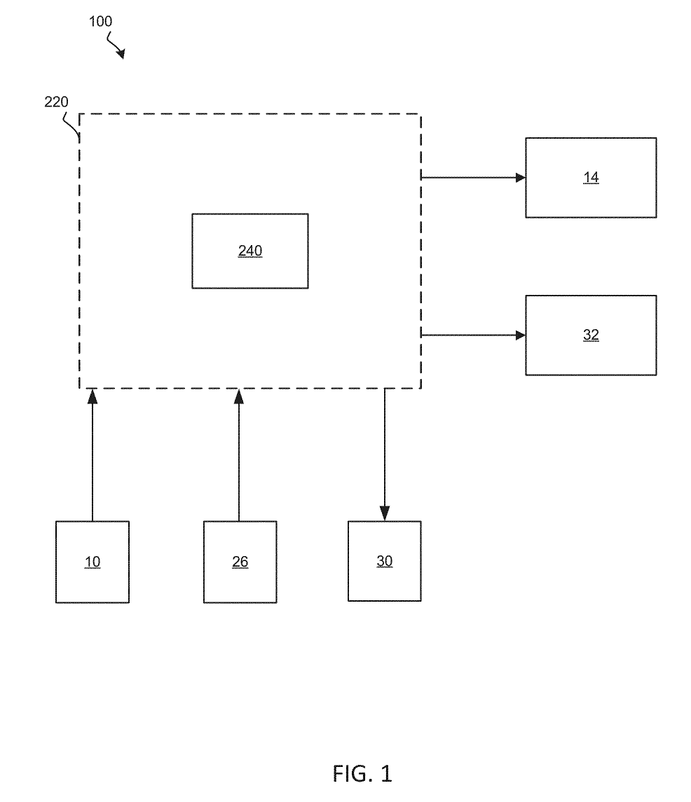

FIG. 1 schematically illustrates an electronic transmission system 100 for an automotive vehicle according to the present disclosure. The electronic transmission system 100 includes at least one controller 220. While depicted as a single unit for illustrative purposes, the controller 220 may additionally include one or more other controllers, collectively referred to as a “controller.” The controller 220 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 220 in controlling the vehicle.

In accordance with various embodiments, the controller 220 implements an electronic transmission control system 240 as shown in FIG. 1. That is, suitable software and/or hardware components of the controller 220 (e.g., a processor and a computer-readable storage device) are utilized to provide an electronic transmission control system 240 that is used in conjunction with an automotive vehicle.

In various embodiments, the electronic transmission control system 240 is used to control a transmission of an automotive vehicle. The electronic transmission control system 240 receives input from one or more vehicle sensors 26. The vehicle sensors 26 are configured to measure and capture data on one or more vehicle characteristics, including, but not limited to, vehicle speed, brake pedal position, throttle position, transmission range selection, and vehicle occupancy status. In the illustrated embodiment, the sensors 26 include, but are not limited to, an accelerometer, a speed sensor, a heading sensor, gyroscope, steering angle sensor, a capacitive sensor, a pressure sensor, or other sensors that sense observable conditions of the vehicle or the environment surrounding the vehicle and may include RADAR, LIDAR, optical cameras, thermal cameras, ultrasonic sensors, infrared sensors, light level detection sensors, and/or additional sensors as appropriate. In some embodiments, the electronic transmission control system 240 transmits control commands to a plurality of actuators 30 configured to receive control commands to control steering, shifting, throttle, braking or other aspects of the vehicle.

The electronic transmission control system 240 also receives input from an electronic gear shifter 10. In some embodiments, the electronic gear shifter 10 is mounted to a steering column of a vehicle. The position of the electronic gear shifter 10, or a sequence of position changes, indicates the operator's desired range selection, as discussed in greater detail herein.

The controller 220 transmits a control signal from the electronic transmission control system 240 to a transmission 14 configured to transmit power from a vehicle propulsion system to a plurality of vehicle wheels according to selectable speed ratios. The control signal indicates the desired range selected by the vehicle operator. Additionally, the controller 220 is electronically connected to a display 32. The display 32 can be any vehicle display configured to convey information to the vehicle operator, including, for example, an infotainment screen or a portion of the vehicle dashboard configured to display step-by-step instructions to the operator, as well as other vehicle information. In some embodiments, the display 32 includes one or more indicators, such as an arrow indicator, mounted on or near the electronic gear shifter 10.

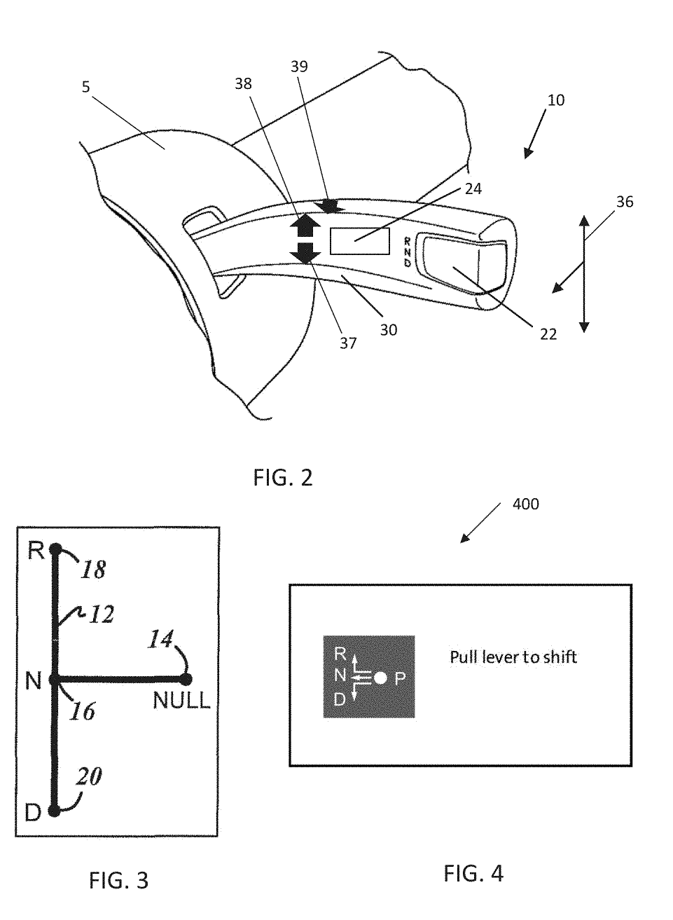

With reference to FIG. 2, a steering column 5 of a vehicle includes an exemplary electronic gear shifter 10 that is mounted to the vehicle steering column 5 and is used to select different gears of the automatic transmission 14. In this particular example, the electronic gear shifter 10 enables an operator to select between reverse (R), neutral (N), and drive (D) gears by moving the electronic gear shifter 10 up, down, and toward and away from the operator, as indicated by the arrows 36. When the operator disengages or releases the electronic gear shifter 10, it returns to a null or rest position.

The electronic gear shifter 10 generally includes a control arm 30. The control arm 30 is generally an elongated lever or stalk that extends from the steering column 5 and provides the operator with the ability to cycle through the transmission options R, N, and D. The control arm 30 is generally spring-loaded or otherwise biased so that when the operator is done selecting transmission options, the control arm 30 returns to the null position via a shift pattern 12 (see FIG. 3). In some embodiments, the shift pattern is machined or otherwise formed on a surface of a groove plate so that an end of the control arm 30 can move within the grooves and follow the shift pattern when the electronic gear shifter 10 is engaged. A separate button 22 for putting the vehicle in park is shown on the electronic gear shifter 10.

In some embodiments, the electronic gear shifter 10 includes a capacitive sensor 24. In some embodiments, operator contact with the capacitive sensor 24 results in shifting instructions to be displayed to the operator via the display 32, such as an infotainment screen or dashboard information screen, as discussed in greater detail herein. In some embodiments, operator contact with the capacitive sensor 24 results in illumination of one or more indicators to guide the operator through a sequence of shifter movements to select the desired transmission gear.

As best illustrated in FIG. 3, the electronic gear shifter 10 generally follows a four-position shift pattern 12 where the null position 14 can only be accessed from the middle of the shift pattern (that is, the operator must shift from neutral 16 to the null position 14, the operator cannot shift directly from reverse 18 or drive 20 to the null position 14). The four-position shift pattern 12 shown in FIG. 3 is only one example of a transmission shift pattern. The exemplary transmission options (R, N, D) are only some of the basic options; additional transmission features such as economy modes, low gear modes, towing modes, etc. could be added to the shift pattern, for example and without limitation.

With continued reference to FIG. 2, operator contact with a sensor located on the electronic shifter 10, such as the capacitive sensor 24, results in one or more shifting instructions displayed to the operator. In some embodiments, a series of indicators 37, 38, 39 will illuminate to direct the operator to adjust a position of the electronic gear shifter 10, or will direct the operator through a sequence of position changes. With reference to FIG. 4, in some embodiments, visual or auditory instructions will be displayed to the operator via a display, such as a vehicle infotainment screen, to direct the operator through a sequence of shifter positions to select the desired or predicted transmission gear. These instructions may, in some embodiments, be in the form of a pictorial and/or a written description.

Some electronic shift systems rely on the operator knowing the correct shift pattern to select the desired gear and, if the operator makes an error, transmit an error signal or reactively instruct the operator regarding the correct shift pattern. Because the electronic shifter is often a freely-moving joystick, the shifter can be freely moved by the operator. However, the controller will not recognize anything but a specific shift pattern as a direction to shift the transmission. Additionally, for some gear selections, depression of the brake is required. If the controller does not recognize a brake pedal depression, the controller will not recognize the operator's adjustment of the shifter as a gear shift request.

Therefore, many electronic systems reactively inform the operator of a shifting error, such as, for example, movement of the shifter without depression of the brake pedal. To avoid shifting delays due to operator error, embodiments discussed herein proactively determine an operator's intent to shift gears by analyzing vehicle sensor information. The vehicle sensor information includes, for example and without limitation, brake pedal position, passenger cabin occupancy detection, ignition position, elapsed time since key on (that is, the time elapsed in the current ignition cycle), current transmission position, contact with one or more capacitive sensors, vehicle position information determined from one or more cameras, operator's seat position and/or elapsed time since an adjustment to the operator's seat position, vehicle mirror position and/or elapsed time since an adjustment to the position of one or more of the vehicle mirrors, etc.

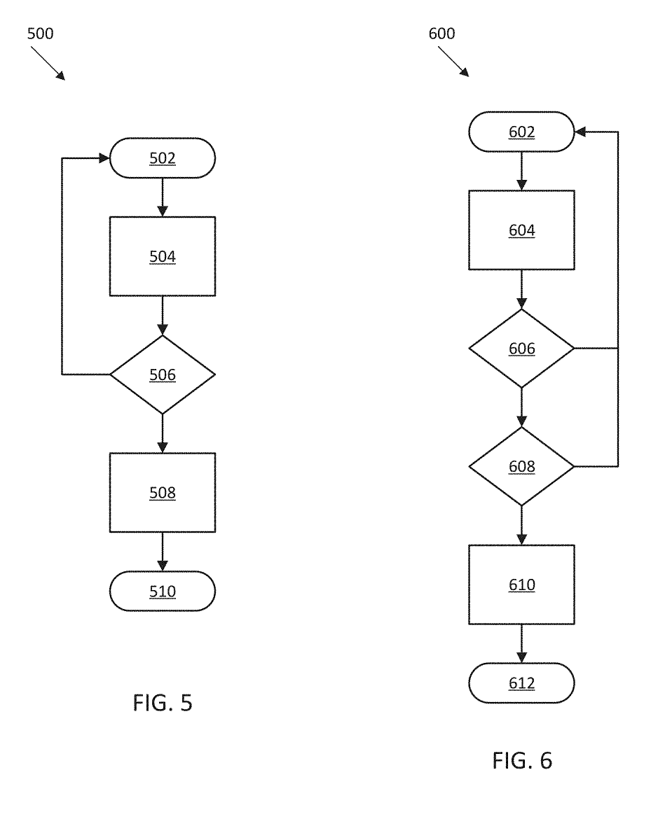

Referring now to FIG. 5, a method 500 for determining an operator's intent to select a transmission gear and determining a sequence of instructions to guide an operator through a transmission gear selection according to the present disclosure is illustrated in flowchart form. In some embodiments, a controller, such as the controller 220, receives sensor data indicative of an impending transmission gear selection using an electronic gear selector and, using the sensor data including data indicative of a position adjustment of the electronic gear selector, determines a sequence of instructions to move the electronic gear selector and, in some embodiments, displays the sequence of instructions to the operator to guide the operator through the sequence of position adjustments to select the desired gear. The method 500 can be utilized in connection with the electronic transmission control system 240 and the electronic gear shifter 10 or by other systems associated with or separate from the vehicle, in accordance with exemplary embodiments. The order of operation of the method 500 is not limited to the sequential execution as illustrated in FIG. 5, but may be performed in one or more varying orders, or steps may be performed simultaneously, as applicable in accordance with the present disclosure.

As shown in FIG. 5, the method 500 starts at 502 and proceeds to 504. At 504, the controller receives sensor data from one or more vehicle sensors, such as the sensors 26. The sensor data includes, in some embodiments, brake pedal position, passenger cabin occupancy detection, ignition position, elapsed time since key on, current transmission position, contact with one or more capacitive sensors, vehicle position information determined from one or more cameras, operator's seat position and/or elapsed time since an adjustment to the operator's seat position, vehicle mirror position and/or elapsed time since an adjustment to the position of one or more of the vehicle mirrors, a selection and/or establishment of a different operator profile, etc.

Next, at 506, the controller determines whether the sensor data indicates whether the operator intends to select a transmission gear by moving the electronic gear shifter. In some embodiments, determining whether the sensor data indicates whether the operator intends to select a transmission gear includes analyzing the sensor data to determine if a first condition is satisfied. Determining whether the operator intends to select a transmission gear includes, in some embodiments, for example and without limitation, the time elapsed since key on if the vehicle is in park, vehicle position information indicating the vehicle is in a parking space and the vehicle has been keyed on, passenger cabin occupancy detection, contact with a capacitive sensor located on or near the electronic gear shifter, such as the sensor 24 shown in FIG. 2, etc.

If the determination at 506 is positive, that is, the sensor data indicates that the operator intends to select a transmission gear, the method 500 proceeds to 508. At 508, the controller determines the expected transmission gear change based on the sensor data. For example, and without limitation, the controller determines from the sensor data whether the operator intends to shift from park to drive, from park to reverse, or from reverse to drive, or vice versa.

For example, determining whether the operator intends to shift from park to drive or park to reverse includes, in some embodiments, analyzing the sensor data to determine if the vehicle transmission is currently in park, an elapsed time since a vehicle key on event, and/or camera data indicative of the vehicle's parking location (that is, if the vehicle has a clear path to travel forward (indicative of an intended selection of drive) or backward (indicative of an intended selection of reverse).

In some embodiments, at 508, the controller also generates instructions, which may include a single instruction or a sequence of instructions, to the operator based on the determined transmission gear selection. In some embodiments, the instructions take the form of visual, including pictorial and textual, instructions to the vehicle operator illustrating a sequence of electronic gear shifter position changes and/or instruction to depress the brake pedal. In some embodiments, the instructions include visual directional indicators to the operator illustrating one or more electronic gear shifter position adjustments. The method 500 then proceeds to 510 and ends.

If the determination at 506 is negative, that is, the sensor data does not indicate that the operator intends to select a transmission gear, the method 500 returns to 502 and proceeds as discussed herein.

In some embodiments, the controller determines the state of two or more separate conditions before determining the instructions to deliver to the vehicle operator. In some embodiments, the separate conditions include one or more of a brake pedal position, contact with one or more capacitive switches, adjustments to the operator seat position within an elapsed time, adjustments to one or more vehicle mirrors within an elapsed time, etc., for example and without limitation.

FIG. 6 illustrates a flowchart of another exemplary method for determining an operator's intent to select a transmission gear and determining a sequence of instructions to guide an operator through a transmission gear selection according to the present disclosure. In some embodiments, a controller, such as the controller 220, receives sensor data indicative of an operator's intent to select a transmission gear using an electronic gear selector and, using the sensor data and data indicative of a position adjustment of the electronic gear selector, determines a sequence of instructions to move the electronic gear selector to perform a gear selection and, in some embodiments, displays the sequence of instructions to the operator to guide the operator through the sequence of position adjustments. The method 600 can be utilized in connection with the electronic transmission control system 240 and the electronic gear shifter 10 or by other systems associated with or separate from the vehicle, in accordance with exemplary embodiments. The order of operation of the method 600 is not limited to the sequential execution as illustrated in FIG. 6, but may be performed in one or more varying orders, or steps may be performed simultaneously, as applicable in accordance with the present disclosure.

As shown in FIG. 6, the method 600 starts at 602 and proceeds to 604. At 604, the controller receives sensor data from one or more vehicle sensors, such as the sensors 26. The sensor data includes, in some embodiments, brake pedal position, passenger cabin occupancy detection, ignition position, elapsed time since key on, current transmission position, contact with one or more capacitive sensors, vehicle position information determined from one or more cameras, operator's seat position and/or elapsed time since an adjustment to the operator's seat position, vehicle mirror position and/or elapsed time since an adjustment to the position of one or more of the vehicle mirrors, a selection and/or establishment of a different operator profile, etc.

Next, at 606, the controller determines whether a first condition has been satisfied, such as determining whether the sensor data indicates that a new or different operator intends to select a transmission gear. A new or different operator is one that the controller determines may not have previously operated the vehicle and thus may not be familiar with the sequence of electronic gear shifter position adjustments to select a transmission gear. Determining whether the sensor data indicates that a new or different operator is operating the vehicle and intends to select a transmission gear includes, in some embodiments, analyzing the sensor data to determine if the operator's seat position has been adjusted within an elapsed time such as, for example, the previous minute and/or analyzing the sensor data to determine if a vehicle mirror position has been adjusted within an elapsed time such as, for example, the previous minute and/or data indicating a selection of a different operator profile. A change to the operator's seat position and/or a change to the position of a vehicle mirror and/or selection and/or establishing of a different operator profile can indicate that a new or different operator is operating the vehicle and may not be familiar with transmission gear selection using an electronic gear selector, such as the electronic gear selector 10. If the determination at 606 is positive, that is, the first condition has been satisfied, the method 600 proceeds to 608.

At 608, the controller determines whether a second condition has been satisfied. In some embodiments, the second condition includes determining whether a capacitive sensor is active (that is, that the operator has made contact with the capacitive sensor) and/or a brake pedal position indicates that the brake pedal is depressed. If the second condition has been satisfied, the method 600 proceeds to 610. At 610, the controller determines the expected transmission gear change based on the sensor data. For example, and without limitation, the controller determines from the sensor data whether the operator intends to shift from park to drive, from park to reverse, or from reverse to drive, or vice versa. In some embodiments, the determination of the operator's desired gear selection is made by analyzing the sensor data as discussed above with respect to method 500.

In some embodiments, at 610, the controller also generates instructions, which may include a single instruction or a sequence of instructions, to the operator based on the determined transmission gear selection. In some embodiments, the instructions take the form of visual, including pictorial and textual, instructions to the vehicle operator illustrating a sequence of electronic gear shifter position changes and/or instruction to depress the brake pedal, such as the pictorial and textual instructions illustrated in FIG. 4. In some embodiments, the instructions include visual directional indicators to the operator illustrating one or more electronic gear shifter position adjustments, such as the indicators 37, 38, 39 shown in FIG. 2. The method 600 then proceeds to 612 and ends.

If the determination made at 606 is negative, that is, the first condition is not satisfied, or the determination made at 608 is negative, that is, the second condition is not satisfied, the method 600 returns to 602 and proceeds as discussed herein.

In some embodiments, the controller determines a sequence of instructions and displays the instructions to the operator after each of one or more conditions is satisfied. For example and without limitation, the separate conditions include one or more of a brake pedal position, contact with one or more capacitive switches, adjustments to the operator seat position within an elapsed time, adjustments to one or more vehicle mirrors within an elapsed time, etc.

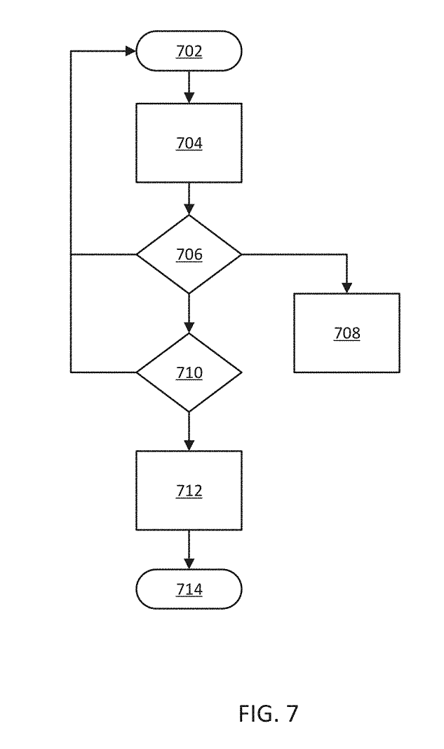

FIG. 7 illustrates a flowchart of another exemplary method for determining an operator's intent to select a transmission gear and determining a sequence of instructions to guide an operator through a transmission gear selection according to the present disclosure. In some embodiments, a controller, such as the controller 220, receives sensor data indicative of an operator's intent to select a transmission gear using an electronic gear selector and, using the sensor data and data indicative of a position adjustment of the electronic gear selector, determines a sequence of instructions to move the electronic gear selector to perform a gear selection and, in some embodiments, displays the sequence of instructions to the operator to guide the operator through the sequence of position adjustments. The method 700 can be utilized in connection with the electronic transmission control system 240 and the electronic gear shifter 10 or by other systems associated with or separate from the vehicle, in accordance with exemplary embodiments. The order of operation of the method 700 is not limited to the sequential execution as illustrated in FIG. 7, but may be performed in one or more varying orders, or steps may be performed simultaneously, as applicable in accordance with the present disclosure.

As shown in FIG. 7, the method 700 starts at 702 and proceeds to 704. At 704, the controller receives sensor data from one or more vehicle sensors, such as the sensors 26. The sensor data includes, in some embodiments, brake pedal position, passenger cabin occupancy detection, ignition position, elapsed time since key on, current transmission position, contact with one or more capacitive sensors, vehicle position information determined from one or more cameras, operator's seat position and/or elapsed time since an adjustment to the operator's seat position, vehicle mirror position and/or elapsed time since an adjustment to the position of one or more of the vehicle mirrors, a selection and/or establishment of a different operator profile, etc. the sensor data received at 704 is used by the controller to determine the transmission gear selection input expected from the vehicle operator.

Next, at 706, the controller determines whether a first condition has been satisfied, such as determining a brake pedal position. If the determination at 706 is positive, that is, the first condition has been satisfied and the sensor data indicates that the brake pedal has been depressed, the method 700 proceeds to 708. At 708, the controller generates an instruction to the operator regarding the next position adjustment for the electronic gear shifter. In some embodiments, the instruction is illumination of an indicator, such as one or more of the indicators 37, 38, 39 shown in FIG. 2. For example and without limitation, if the controller determines the operator intends to shift from park to drive, the controller will first illuminate the indicator 39 to direct the operator to pull the electronic gear shifter rearward or toward the operator to a rearward position.

If the determination at 706 is positive, the method 700 will also proceed to 710. At 710, the controller determines whether a second condition is also satisfied, in addition to satisfaction of the first condition. In some embodiments, the second condition is whether the electronic gear shifter is in the rearward position. At this step in the method 700, the controller is verifying whether the operator has performed the first instructed step, that is, in this example, pulling the electronic gear shifter to the rearward position.

If the determination at 710 is positive, that is, the electronic gear shifter is in the rearward position, the method 700 proceeds to 712. At 712, the controller generates additional instructions for the operator regarding the next position adjustment, or sequence of position adjustments for the electronic gear shifter. In some embodiments, the instruction is illumination of one or more of the indicators 37, 38, 39. To continue the example discussed above with respect to step 706, if the controller determines that the operator intends to shift from park to drive, the controller will next illuminate the indicator 37, shown as a downward facing arrow in FIG. 2. Additional instructions may be conveyed to the operator if additional position adjustments of the electronic gear shifter are needed to indicate the selected transmission gear. From 712, the method 700 proceeds to 714 and ends.

If the determination made at 706 is negative, that is, the first condition is not satisfied, or the determination made at 710 is negative, that is, the second condition is not satisfied, the method 700 returns to 702 and proceeds as discussed herein.

The methods discussed herein are merely exemplary and the use of additional sensor data not explicitly discussed in the examples illustrated by FIGS. 5-7 may be used to determine the operator's intent to select a transmission gear and for determining and displaying a sequence of instructions to the operator to successfully complete the transmission gear selection. In some embodiments, one or more of the methods discussed herein may run automatically upon detection of a key on condition, or may be selectively turned on or off.

The methods discussed herein may be used with a column-mounted electronic shifter, such as the shifter 10 illustrated in FIG. 2. However, the methods discussed herein may be used with an electronic shift system located anywhere within the vehicle.

It should be emphasized that many variations and modifications may be made to the herein-described embodiments the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may he approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. it is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should he interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a. common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a. list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for determining a transmission gear selection, the method comprising:
providing a vehicle sensor configured to measure a vehicle characteristic;
providing at least one controller in communication with the vehicle sensor;
receiving, by the controller, sensor data indicative of the vehicle characteristic;
determining, by the controller, an intended transmission gear selection; and
generating, by the controller, a control signal including an instruction for selection of the intended transmission gear selection.

2. The method of claim 1, wherein the vehicle characteristic includes one or more of a brake pedal position, a passenger cabin occupancy detection, an ignition position, an elapsed time since a vehicle key on event, a current transmission position, a contact with a capacitive sensor, a vehicle position, an operator seat position, an elapsed time since an adjustment to the operator seat position, a vehicle mirror position, and an elapsed time since an adjustment to the position of the vehicle mirror.

3. The method of claim 1, wherein determining the intended transmission gear selection comprises analyzing the sensor data to determine if a first condition is satisfied.

4. The method of claim 3, wherein the first condition includes one or more of the adjustment to the operator seat position within a predetermined elapsed time and the adjustment to the position of the vehicle mirror within a predetermined elapsed time.

5. The method of claim 3, wherein the predetermined elapsed time is a minute since a vehicle key on event.

6. The method of claim 3, wherein generating the instruction for selection of the intended transmission gear selection comprises analyzing the sensor data to determine if a second condition is satisfied.

7. The method of claim 6, wherein the second condition includes one or more of the brake pedal position is a depressed position and contact with the capacitive sensor.

8. The method of claim 1, wherein the instruction includes pictorial directions to change a position of an electronic gear selector.

9. The method of claim 1, wherein the instruction includes textual directions to change a position of an electronic gear selector.

10. The method of claim 1, wherein the instruction includes auditory directions to change a position of an electronic gear selector.

11. A method for instructing a vehicle operator, comprising:
providing a vehicle sensor configured to measure a vehicle characteristic;
providing at least one controller in communication with the vehicle sensor;
receiving, by the controller, sensor data indicative of the vehicle characteristic;
determining, by the controller, whether a first condition is satisfied;
if the first condition is satisfied, generating a first control signal including a first instruction;
determining, by the controller, whether a second condition is satisfied; and
if the first and second conditions are satisfied, generating, by the controller, a second control signal including a second instruction.

12. The method of claim 11, wherein the first and second instructions include pictorial directions to change a position of an electronic gear selector.

13. The method of claim 11, wherein the vehicle characteristic includes one or more of a brake pedal position, a passenger cabin occupancy detection, an ignition position, an elapsed time since a vehicle key on event, a current transmission position, a contact with a capacitive sensor, a vehicle position, an operator seat position, an elapsed time since an adjustment to the operator seat position, a vehicle mirror position, and an elapsed time since an adjustment to the position of the vehicle mirror.

14. The method of claim 11, wherein determining whether the first condition is satisfied includes determining whether a brake pedal position is in a depressed position.

15. The method of claim 14, wherein the first instruction includes illumination of an indicator on an electronic gear selector indicating a direction to adjust a position of the electronic gear selector to a first adjusted position.

16. The method of claim 15, wherein determining whether the second condition is satisfied includes verifying that the electronic gear selector is in the first adjusted position.

17. The method of claim 16, wherein the second instruction includes illumination of an indicator on the electronic gear selector indicating a direction to adjust the position of the electronic gear selector to a second adjusted position.
